(19) United States
(12) Patent Application Publication
(10) Pub. No.: US 2026/0171803 A1
(43) Pub. Date: Jun. 18, 2026

(54) TWO-STREAM LSTM METHOD FOR PREDICTING POWER LOAD OF PORT SHORE

(71) Applicant: China Three Gorges University, Yichang (CN)

(72) Inventors: Shouzhi XU, Yichang (CN); Yannan JIAO, Yichang (CN); Mei YU, Yichang (CN); Tian WU, Yichang (CN); Jia ZHU, Yichang (CN); Huan ZHOU, Yichang (CN); Xiaojun LIU, Yichang (CN); Yang LI, Yichang (CN); Bibo XIAO, Yichang (CN); Kai MA, Yichang (CN); Rui CHEN, Yichang (CN); Liang ZHAO, Yichang (CN); Ke WANG, Yichang (CN); Liping FAN, Yichang (CN)

(73) Assignee: China Three Gorges University, Yichang (CN)

(21) Appl. No.: 19/532,052

(22) Filed: Feb. 6, 2026

(30) Foreign Application Priority Data
Sep. 11, 2025 (CN) 202511300383.9

(51) Int. Cl. H02J 3/00; G06N 3/0442; G06N 3/048; H02J 103/30; H02J 105/30

(52) U.S. Cl. CPC H02J 3/003; G06N 3/0442; G06N 3/048; H02J 2103/30; H02J 2105/31

(57) ABSTRACT

The present disclosure relates to the technical field of electric power engineering, in particular to a two-stream Long Short-Term Memory (LSTM) method for predicting power load of port shore power. Loads. The method entails collecting longitudinal data to identify factors that affect power load data, performing correlation analysis to classify dominant and auxiliary features power loads; separately modeling the dominant and auxiliary features and generating a fusion feature map; constructing a Bayesian Optimization-Long Short-Term Memory (BO-LSTM) neural network, and inputting a fusion feature map into a two-stream time series learning module, extracting a deep representation of the dominant and auxiliary features, then introducing a channel attention mechanism is to weight a fusion feature vector, and outputting a power load prediction value by a residual correction module. The present disclosure significantly improves the prediction accuracy and robustness, and supports the real-time scheduling of the port shore power system.

### TECHNICAL FIELD

The present disclosure relates to the technical field of electric power engineering, in particular to a two-stream Long Short-Term Memory (LSTM) method for predicting power load of port shore.

### BACKGROUND

With the rapid development of the port shore power business, power load forecasting has become a critical step in enhancing energy efficiency and operational reliability. As the global shipping industry accelerates its transition toward green power practices, international conventions and national environmental regulations have imposed stringent restrictions on emissions from berthed vessels. Serving as a core facility to replace auxiliary engine power generation on ships, shore power systems exhibit load fluctuations influenced by multiple factors such as vessel type, berth operation cycles, and weather conditions. These loads possess structural characteristics distinct from traditional industrial or residential loads: primarily triggered by ship berthing behaviors, they demonstrate complex dynamic patterns marked by high noise, intermittency, abruptness, and heterogeneity. Conventional prediction methods often struggle to adequately model temporal dependencies and are highly sensitive to parameter configurations, frequently leading to reduced prediction accuracy and limited generalization capability due to suboptimal model tuning.

In recent years, the integration of deep learning and intelligent optimization algorithms have provided new approaches for forecasting port shore power load. Long short-term memory (LSTM) networks have been widely adopted in energy load forecasting due to their strong capability in modeling sequential data. However, their performance heavily depends on hyperparameter combinations. To address the inefficiency and local optimum risks associated with manual parameter tuning, Bayesian optimization has been introduced. By constructing a surrogate model to approximate the objective function and guide the sampling direction, this method enables efficient exploration of the optimal hyperparameter combinations with fewer trials, thereby achieving near-global optimization under limited computational cost.

At present, given the differences in temporal dependencies and feature distributions between time series data of power load and status data of ship operation in port shore power systems, there is an urgent need for a composite method that integrates Bayesian optimization with two-stream LSTM. This approach aims to overcome limitations in parameter tuning and feature modeling inherent in existing methods, thereby providing precise technical support for intelligent scheduling and energy efficiency management in port shore power systems.

### SUMMARY

Aiming at the above problems of existing technology, this present disclosure provides a two-stream Long Short-Term Memory (LSTM) method for predicting power load of port shore. This method effectively solves limitations of existing methods in parameter tuning and feature modeling, thereby significantly enhancing prediction accuracy and robustness.

To achieve the above purposes, the present disclosure proposes a two-stream LSTM method for predicting power load of port shore, including:
S1, using longitudinal data to select and collect factors that affect power load data, obtaining a multivariate time series data set D1, and preprocessing the data set D1 to obtain a data set D2;
S2, performing correlation analysis to classify dominant and auxiliary features based on a correlation between each variable and load in a Maximal Information Coefficient (MIC) quantitative data set D2; inputting dominant and auxiliary features into separate heterogeneous LSTM branches for modeling, dominant features undergo bidirectional LSTM modeling while auxiliary features undergo unidirectional LSTM modeling; concatenating output results to generate a fusion feature map;
S3, constructing a Bayesian Optimization-Long Short-Term Memory (BO-LSTM) neural network, and inputting the fusion feature map into a two-stream time series learning module, extracting a deep representation of the dominant and auxiliary features respectively, and concatenating them, then introducing a channel attention mechanism to weight a fusion feature vector. Finally, outputting a power load prediction value using a residual correction module.

In some embodiments, in S1, the factors that affect the power load data include ship berthing information, meteorological environment parameters, and port scheduling data, the ship berthing information includes ship type, berthing start time, and end time, along with berthing duration. The meteorological environment parameters include temperature and rainfall of a predicted area, and the port scheduling data include berth usage status, expected berthing plan, current operation progress percentage, and remaining operation time.

In some embodiments, in S1, steps of preprocessing the data set D1 include data cleaning, missing value handling, data standardization, timing alignment and enhancement; the longitudinal data selection is based on a timestamp alignment mechanism to filter a time series dimension of associated data, specific steps of using the longitudinal data selection to collect the factors that affect the power load data are as follows:
S11, setting a data slicing rule according to a port operation cycle, and extracting a continuous valid load section;
S12, eliminating invalid data during non-operation periods;
S13, ensuring that filtered data remains continuous and seamless along a timeline, with a missing rate below a preset threshold.

In some embodiments, in S2, the dominant feature is a highly correlated feature, and the auxiliary feature is a lowly correlated feature.

In some embodiments, in S2, the correlation analysis is performed, and the dominant features along with auxiliary features are divided based on the correlation between each variable and load in MIC quantitative data set D2; the dominant and auxiliary features are input into the heterogeneous LSTM branch modeling respectively, the dominant features are modeled by bidirectional LSTM, and the auxiliary features are modeled by unidirectional LSTM, specific steps for concatenating the output results to generate the fusion feature map are as follows:
S21, inputting data: Feature variables contained in the data set D2 are recorded as X={x₁, x₂, . . . , xₙ}, where n represents a number of features, including but not limited to ship berthing information, meteorological parameters, and port scheduling data; a historical load value of the port shore power system is taken as a target variable, which is recorded as y;
S22, calculating MIC: For each pair of features xᵢ and target variable y, calculating the MIC of the feature and load, and a calculation formula is:

$$MIC ( {x}_{i} , y ) = {max}_{{G}_{x} , {G}_{y}} \frac{I * ( {x}_{i} , y ; {G}_{x} , {G}_{y} )}{log min ( \vert {G}_{x} \vert , \vert {G}_{y} \vert )} ;$$

where xᵢ is the characteristic variable of the i-th input, and y denotes the target variable, that is, the load value, Gₓ and G_{y} divide a range of the variable xᵢ and y into different numbers of grids, respectively. I*(xᵢ, y; Gₓ, G_{y}) denotes a maximum mutual information value between variables xᵢ and y under given grid partitions Gₓ and G_{y};
S23, setting a correlation threshold: The threshold θ is set empirically based on several characteristics of a port and a load response intensity; when MIC(xᵢ, y)≥θ, the variables are highly correlated with load changes and are classified as dominant features; conversely, it is classified as an auxiliary feature; a value range of correlation discriminant threshold θ is within an interval [0.5, 0.8];
S24, generating a dominant and auxiliary feature subset: Let the dominant feature set be Xₘₐᵢₙ, the auxiliary feature set be Xₐᵤₓ; an output result is

$$X = {X}_{main} ⋃ {X}_{aux} {X}_{main} ⋂ {X}_{aux} = ∅ ;$$

S25, encoding the dominant and auxiliary features synchronously in separate branches, and concatenating the output representations along the feature dimension, a formula for generating the fusion feature map is:

$${h}_{cat} = [ {h}_{main} ; {h}_{aux} ] ;$$

where h_{cat} denotes the feature vector after fusion, hₘₐᵢₙ denotes a hidden state of the dominant branch, and hₐᵤₓ denotes a hidden state of an auxiliary branch.

In some embodiments, in S3, the BO-LSTM neural network includes a two-stream time series learning module, a Bayesian optimization module, an attention feature fusion module, and a dynamic error correction module; The BO-LSTM network outputs a current time step ŷ^{corrected} as a final prediction result after heterogeneous modeling of dominant and auxiliary features, Bayesian parameter self-optimization, attention-weighted enhancement, and residual correction.

In some embodiments, in S3, the two-stream time series learning module includes the dominant branch and the auxiliary branch. The dominant branch uses bidirectional LSTM, which is divided into forward and backward, and the auxiliary branch uses standard LSTM calculation, where specific steps to obtain the dominant branch are:
S3111, calculating forward LSTM:

$${\vec{h}}_{t}^{bi} = LSTM ( {F}_{main , t} , {\vec{h}}_{t - 1}^{bi} ) ;$$

where

$${\vec{h}}_{t}^{bi}$$

denotes a trend that the system is affected by the historical load data at a current moment, F_{main,t} denotes a dominant feature at the current moment, and

$${\vec{h}}_{t - 1}^{bi}$$

denotes a continuous influence of a historical operation of the port on a current load;
S3112, calculating the backward LSTM in the dominant branch:

$${{h}^{↼}}_{t}^{bi} = LSTM ( {F}_{main , t} , {{h}^{↼}}_{t + 1}^{bi} ) ;$$

where

$${{h}^{↼}}_{t + 1}^{bi}$$

denotes an influence of future operating status on a current load trend;
S3113, concatenating the forward and backward hidden states along the feature dimension to form a comprehensive judgment basis hₜ^{bi} at the current moment:

$${h}_{t}^{bi} = [ {\vec{h}}_{t}^{bi} ‖ {{h}^{↼}}_{t}^{bi} ] ;$$

specific steps to obtain the auxiliary branch are:
S3121, performing gating computations including a forget gate fₜ, input gate, iₜ, and output gate o_{f}:

$${f}_{t} = σ ( {W}_{f} \cdot [ {h}_{t - 1}^{aux} , {D}_{2}^{aux} ] + {b}_{f} ) ;$$

$${i}_{t} = σ ( {W}_{i} \cdot [ {h}_{t - 1}^{aux} , {D}_{2}^{aux} ] + {b}_{i} ) ;$$

$${o}_{t} = σ ( {W}_{o} \cdot [ {h}_{t - 1}^{aux} , {D}_{2}^{aux} ] + {b}_{o} ) ;$$

where a Sigmoid function σ(⋅) is used to control an opening degree of a gate, W_{f}, Wᵢ, and Wₒ denote weight matrices for the forget gate, input gate, and output gate, respectively, and the auxiliary features are mapped to a gating space to control whether new information is introduced or an old state is retained,

$${h}_{t - 1}^{aux}$$

denotes an influence of port auxiliary information on a current prediction at the previous moment, D₂^{aux} denotes the auxiliary features input at a current moment, b_{f}, bₜ, and bₒ are bias items corresponding to the forget gate, input gate, and output gate, respectively, along with a threshold of the gating activation function, which is adjusted to avoid all gates being opened or closed at the same time;
S3122, updating hidden state, that is, an instantaneous impact prediction of shore power load under the current berthing-job-scheduling behavior:

$${h}_{t}^{aux} = {o}_{t} ⊙ tanh ( {c}_{t} ) ;$$

where

$${h}_{t}^{aux}$$

denotes a final output of the current time step, and cₜ denotes a long-term memory state formed by integrating an influence of historical load and new inputs at the current time step.

In some embodiments, in S3, specific steps of using the Bayesian optimization module to optimize the LSTM network are as follows:
S321, using a hyperparameter optimization objective function to minimize a root mean square error (RMSE) on a validation set, wherein optimized LSTM network hyperparameters include hidden layers, learning rate, and dropout rate, a hyperparameter optimization objective function calculation formula is:

$$arg {min}_{θ} RMSE = \sqrt{\frac{1}{N} {\sum }_{i = 1}^{N} {( {y}_{i} - {y}_{i} ( θ ) )}^{2}} ;$$

where θ denotes a hyperparameter combination, RMSE denotes the root mean square error, N denotes a total number of time slice samples for parameter adjustment and evaluation, yᵢ denotes a historical observation value of the shore power system at the i-th time point, and ŷᵢ(θ) denotes a load output obtained by a current prediction;
S322, using a tree structure Parzen estimator TPE surrogate model to update a posterior distribution of parameters, and selecting a parameter combination that has a greatest potential dynamically to reduce a prediction error, a calculation formula is:

$$p ( θ \vert y ) = \frac{p ( y \vert θ ) p ( θ )}{p ( y )} ;$$

where y denotes a deviation between a shore power load prediction result and a real value, p(θ) denotes a hyperparameter prior distribution, represents an empirical preference of a parameter value, p(y|θ) denotes a likelihood function, that is, a distribution of the prediction error under given parameters, p(θ|y) denotes a posterior probability distribution;
S323, constructing the posterior probability distribution, and maximizing an expected improvement (EI) function in each iteration, a calculation formula for the EI function is:

$$EI ( θ ) = {\int }_{- ∞}^{{y}^{*}} ( {y}^{*} - y ) p ( y \vert θ ) dy ;$$

where EI(θ) denotes an expected improvement value, y* denotes a current optimal error value, y denotes a random variable of a model prediction error under the current parameter combination, and it is used to measure a performance uncertainty of the parameter combination.

In some embodiments, in S3, a fusion output weighting module is used to introduce the concatenated dominant and auxiliary features into the channel attention mechanism to weight the fusion feature vectors. Specific steps are as follows:
S331, calculating a channel attention weight:

$$β = Softmax ( {W}_{2} \cdot σ ( {W}_{1} \cdot GAP ( {h}_{cat} ) ) ) ;$$

where β denotes an importance weight vector of the fusion channel, softmax denotes a normalized exponential function, a response of all channels is compressed into an interval of [0,1] and normalized, W₁ and W₂ are learnable weight matrices used to model complex weighting relationships among different features, σ(⋅) denotes a ReLU function, GAP(⋅) denotes global average pooling, an average response intensity of each feature at all time steps, and h_{cat} denotes the feature vector after fusion, which includes a complete representation of all key features at the current time in a time dimension;
S332, outputting the fusion weighted:

$${h}_{fuse} = β \cdot {h}_{cat} ;$$

where h_{fuse} denotes a new feature map formed by the dominant and auxiliary features after attention weighting is used for subsequent prediction tasks.

In some embodiments, in S3, the specific steps of using a dynamic error correction module to suppress error accumulation through residual feedback are as follows:
S341, using a residual feedback formula to calculate a residual feedback:

$${\hat{y}}^{corrected} = {\hat{y}}_{t} + λ \cdot {μ}_{E} ;$$

$${μ}_{E} = \frac{1}{W} {\sum }_{k = 1}^{W} {e}_{t - k} ;$$

where ŷ^{corrected} denotes a final prediction result obtained after adding dynamic residual feedback, ŷᵢ(θ) denotes an uncorrected output result of the BO-LSTM model, and λ denotes a factor that dynamically adjusts the residual feedback intensity, a larger factor indicates a greater need for error correction, HE denotes the average level of W prediction deviation is used to capture a trend of systematic prediction deviation, where et-k represents the prediction error at a k-th past time step, and W denotes a window length;
S342, using an adaptive weight formula to calculate the factor of dynamically adjusting the residual feedback strength and a standard deviation of the historical error in a sliding window, adaptive weight formulas are:

$$λ = Sigmoid ( α \cdot \frac{{σ}_{E}}{{E}_{max}} ) ;$$

$${σ}_{E} = \sqrt{\frac{1}{W} {\sum }_{k = 1}^{W} {( {e}_{t - k} - {μ}_{E} )}^{2} ;}$$

where Sigmoid denotes a compression function, which constrains the feedback factor within an interval of [0,1], α denotes a sensitivity coefficient, regulating the response intensity of the residual feedback mechanism to error fluctuations, σ_{E} denotes the standard deviation of historical errors within the sliding window, and Eₘₐₓ denotes the maximum allowable error threshold for the system, eₜ₋ₖ denotes the prediction error at step t−k, where when the input term of the compression function for the feedback factor approaches zero, the residual feedback mechanism automatically weakens or ceases correction.

Therefore, the present disclosure proposes a two-stream LSTM method for predicting power load of port shore, and its beneficial effects are as follows:

The technical schemes proposed by the present disclosure realize the time series dynamic perception of various factors such as ship type, berth operation cycle and meteorological conditions, effectively improves an accuracy and expression ability of load prediction, significantly reduces a time consumption of parameter adjustment and a consumption of computing resources, effectively suppresses an accumulation of long-term prediction errors, and ensures a stability of forecasting results.

The technical schemes of the present disclosure are further described in detail through the drawings and embodiments below.

### BRIEF DESCRIPTION OF THE DRAWINGS

FIG. 1 is a flow chart of the two-stream Long Short-Term Memory (LSTM) method for predicting power load of port shore in the present disclosure;

FIG. 2 is a Bayesian Optimization-Long Short-Term Memory (BO-LSTM) structure diagram of a two-stream LSTM method for predicting power load of port shore in the present disclosure.

### DETAILED DESCRIPTION OF THE EMBODIMENTS

To provide a clearer explanation of the technical solutions, advantages and objectives, the technical solutions of the embodiments of the present disclosure will be described clearly and comprehensively below. The described embodiments represent only a portion of the embodiments of the present disclosure, rather than all of them. Based on the embodiments of the present disclosure described herein, all other embodiments obtained by those of ordinary skill in the art without creative effort shall fall within the scope of protection of this application.

Unless otherwise defined, the technical or scientific terms used in the present disclosure shall carry the meanings generally understood by those skilled in the art.

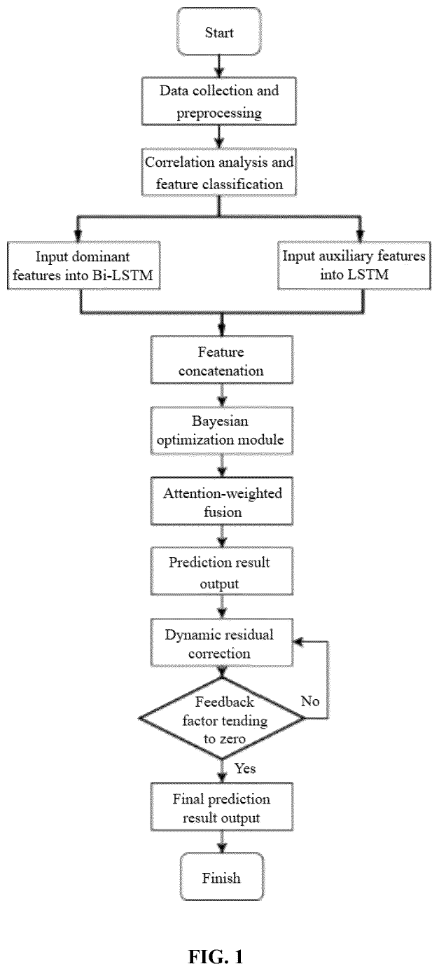

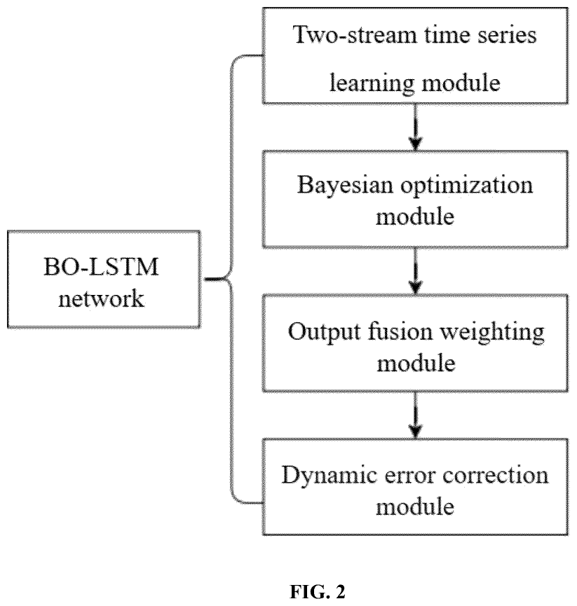

As shown in FIGS. 1-2, the present disclosure provides a two-stream Long Short-Term Memory (LSTM) method for predicting power load of port shore, including the following:
S1, longitudinal data is used to select and collect the factors that affect the power load data, the multivariate time series data set D1 is obtained, and the data set D2 is obtained by preprocessing the data set D1;
S2, correlation analysis is performed, and the dominant and auxiliary features are divided based on the correlation degree between each variable and load in the Maximal Information Coefficient (MIC) quantitative data set D2; the dominant and auxiliary features are input into separate heterogeneous LSTM branches for modeling, the dominant features are modeled by bidirectional LSTM, and the auxiliary features are modeled by unidirectional LSTM, the output results are concatenated to generate a fusion feature map;
S3, the Bayesian Optimization-Long Short-Term Memory (BO-LSTM) neural network is constructed, and the fusion feature map is input into the two-stream time series learning module, where the deep representations of the dominant feature and the auxiliary feature are extracted and concatenated, respectively. Then, the channel attention mechanism is introduced to weight the fusion feature vector. Finally, the power load prediction value is output by the residual correction module.

In S1, the factors that affect the power load data include ship berthing information, meteorological environment parameters, and port scheduling data. ship berthing information includes ship type, berthing start time, and end time, along with berthing duration. Meteorological parameters include temperature and rainfall in the predicted area. Port scheduling data include berth usage status, expected berthing plan, current operation progress percentage, and remaining operation time.

In S1, the steps of preprocessing the data set D1 include data cleaning, missing value processing, data standardization, timing alignment and enhancement; the longitudinal data selection is based on the timestamp alignment mechanism to filter the time series dimension of the associated data. The specific steps of using the longitudinal data selection to collect the factors that affect the power load data are as follows:
S11, the data slicing rules are set according to the port operation cycle, and the continuous effective load section is extracted;
S12, the invalid data in the non-operation period is eliminated;
S13, the filtered data is remained continuous and seamless along a timeline, with a missing rate below a preset threshold.

In S2, the dominant feature is a high correlation feature, and the auxiliary feature is a low correlation feature; the specific steps of correlation analysis are as follows:
S21, data are input: Feature variables contained in the data set D2 are recorded as X={x₁, x₂, . . . , xₙ}, where n represents several features, including but not limited to ship berthing information, meteorological environment parameters, and port scheduling data; a historical load value of the port shore power system is taken as the target variable, which is recorded as y;
S22, MIC is calculated: For each pair of features xᵢ and target variable y, the MIC of the feature and load are calculated, and the calculation formula is:

$$MIC ( {x}_{i} , y ) = {max}_{{G}_{x} , {G}_{y}} \frac{I * ( {x}_{i} , y ; {G}_{x} , {G}_{y} )}{log min ( \vert {G}_{x} \vert , \vert {G}_{y} \vert )} ;$$

where xᵢ is the characteristic variable of the i-th input, and y denotes the target variable, that is, the load value, Gₓ and G_{y} divide a range of the variable xᵢ and y into different numbers of grids, respectively. I*(xᵢ, y; Gₓ, G_{y}) denotes a maximum mutual information value between variables x; and y under given grid partitions Gₓ and G_{y};
S23, a correlation threshold is set: The threshold θ is set empirically based on several characteristics of a port and a load response intensity; when MIC(xᵢ, y)≥θ, the variables are highly correlated with load changes and are divided into dominant features; conversely, they are classified as an auxiliary feature; a value range of correlation discriminant threshold θ is within an interval of [0.5, 0.8];
S24, a dominant and auxiliary feature subset is generated: Let the dominant feature set be Xₘₐᵢₙ, the auxiliary feature set be Xₐᵤₓ; the output result is X=Xₘₐᵢₙ∪XₐᵤₓXₘₐᵢₙ∩Xₐᵤₓ=Ø;
S25, the dominant and auxiliary features in parallel in separate branches, and the encoded outputs are concatenated along a feature dimension, the formula for generating the fusion feature map is:

$${h}_{cat} = [ {h}_{main} ; {h}_{aux} ] ;$$

where h_{cat} denotes the feature vector after fusion, hₘₐᵢₙ denotes a hidden state of the dominant branch, and hₐᵤₓ denotes a hidden state of the auxiliary branch.

In S3, the BO-LSTM neural network includes a two-stream time series learning module, a Bayesian optimization module, an attention feature fusion module, and a dynamic error correction module; the BO-LSTM network outputs a current time step ŷ^{corrected} as a final prediction result after heterogeneous modeling of dominant and auxiliary features, Bayesian parameter self-optimization, attention-weighted enhancement, and residual correction.

In S3, the two-stream time series learning module includes the dominant branch and the auxiliary branch. The dominant branch uses bidirectional LSTM, which is divided into forward and backward, and the auxiliary branch uses standard LSTM calculation, where specific steps to obtain the dominant branch are:
S3111, forward LSTM is calculated:

$${\vec{h}}_{t}^{bi} = LSTM ( {F}_{main , t} , {\vec{h}}_{t - 1}^{bi} ) ;$$

where

$${\vec{h}}_{t}^{bi}$$

denotes a trend that the system is affected by the historical load data at the current moment, F_{main,t} denotes a dominant feature at the current moment, and

$${\vec{h}}_{t - 1}^{bi}$$

denotes a continuous influence of a historical operation of the port on the current load;
S3112, backward LSTM is calculated:

$${{h}^{↼}}_{t}^{bi} = LSTM ( {F}_{main , t} , {{h}^{↼}}_{t + 1}^{bi} ) ;$$

where

$${{h}^{↼}}_{t + 1}^{bi}$$

denotes an influence of future operating status on the current load trend;
S3113, forward and backward hidden states are concatenated along the feature dimension to form a comprehensive judgment basis hₜ^{bi} at the current moment:

$${h}_{t}^{bi} = [ {\vec{h}}_{t}^{bi} \vert \vert {{h}^{↼}}_{t}^{bi} ] ;$$

the specific steps to obtain the auxiliary branch are:
S3121, gating computations are performed, including a forget gate fₜ, input gate, iₜ, and output gate oₜ:

$${f}_{t} = σ ( {W}_{f} \cdot [ {h}_{t - 1}^{aux} , {D}_{2}^{aux} ] + {b}_{f} ) ;$$

$${i}_{t} = σ ( {W}_{i} \cdot [ {h}_{t - 1}^{aux} , {D}_{2}^{aux} ] + {b}_{i} ) ;$$

$${o}_{t} = σ ( {W}_{o} \cdot [ {h}_{t - 1}^{aux} , {D}_{2}^{aux} ] + {b}_{o} ) ;$$

where a Sigmoid function σ(⋅) is used to control an opening degree of a gate, W_{f}, Wᵢ, and Wₒ denote weight matrices for the forget gate, input gate, and output gate, respectively, and the auxiliary features are mapped to a gating space to control whether new information is introduced or an old state is retained,

$${h}_{t - 1}^{aux}$$

denotes an influence of port auxiliary information on a current prediction at a previous moment, D₂^{aux} denotes the auxiliary features input at a current moment, b_{f}, bₜ, and bₒ are bias items corresponding to the forget gate, input gate, and output gate, respectively, along with a threshold of a gating activation function is adjusted to avoid all gates being opened or closed at the same time;
S3122, the hidden state is updated, that is, an instantaneous impact prediction of shore power load under the current berthing-job-scheduling behavior:

$${h}_{t}^{aux} = {o}_{t} ⊙ tanh ( {c}_{t} ) ;$$

where

$${h}_{t}^{aux}$$

denotes a final output of the current time step, and cₜ denotes a long-term memory state formed by integrating the influence of historical load and new inputs at the current time step.

In S3, the specific steps of using the Bayesian optimization module to optimize the LSTM network are as follows:
S321, a hyperparameter optimization objective function are used to minimize a root mean square error (RMSE) on a validation set, wherein optimized LSTM network hyperparameters include hidden layers, learning rate, and dropout rate, a hyperparameter optimization objective function calculation formula is:

$$arg {min}_{θ} RMSE = \sqrt{\frac{1}{N} {\sum }_{i = 1}^{N} {( {y}_{i} - {y}_{i} ( θ ) )}^{2}} ;$$

where θ denotes a hyperparameter combination, RMSE denotes the root mean square error, N denotes a total number of time slice samples for parameter adjustment and evaluation, yᵢ is a historical observation value of the shore power system at the i-th time point, and ŷᵢ(θ) denotes a load output obtained by a current prediction;
S322, the tree structure Parzen estimator TPE surrogate model is used to update a posterior distribution of parameters, and select the parameter combination dynamically that has a greatest potential to reduce the prediction error, the calculation formula is:

$$p ( θ \vert y ) = \frac{p ( y \vert θ ) p ( θ )}{p ( y )} ;$$

where y denotes a deviation between a shore power load prediction result and a real value, p(θ) denotes a hyperparameter prior distribution, represents an empirical preference of a parameter value, p(y|θ) denotes a likelihood function, that is, a distribution of the prediction error under given parameters, p(θ|y) denotes a posterior probability distribution;
S323, the posterior probability distribution is constructed, and an expected improvement (EI) function is maximized in each iteration, the calculation formula of the EI function is:

$$EI ( θ ) = {\int }_{- ∞}^{{y}^{*}} ( {y}^{*} - y ) p ( y \vert θ ) dy ;$$

where EI(θ) denotes an expected improvement value, y* denotes a current optimal error value, y denotes a random variable of a model prediction error under a current parameter combination, and it is used to measure the performance uncertainty of the parameter combination.

In S3, the fusion output weighting module is used to introduce the concatenated dominant and auxiliary features into the channel attention mechanism to weight the fusion feature vectors. The specific steps are as follows:
S331, the channel attention weight is calculated:

$$β = Softmax ( {W}_{2} \cdot σ ( {W}_{1} \cdot GAP ( {h}_{cat} ) ) ) ;$$

where β denotes an importance weight vector of the fusion channel, softmax denotes a normalized exponential function, a response of all channels is compressed into the interval of [0,1] and normalized, W₁ and W₂ are learnable weight matrices used to model complex weighting relationships among different features, σ(⋅) denotes a ReLU function, GAP(⋅) denotes global average pooling, an average response intensity of each feature at all time steps, and h_{cat} denotes the feature vector after fusion, which includes a complete representation of all key features at the current time in a time dimension;
S332, the fusion weighted is output:

$${h}_{fuse} = β \cdot {h}_{cat} ;$$

where h_{fuse} denotes a new feature map formed by the dominant and auxiliary features after attention weighting is used for subsequent prediction tasks.

In S3, specific steps for using a dynamic error correction module to suppress error accumulation through residual feedback are as follows:
S341, the residual feedback formula is used to calculate the residual feedback:

$$\begin{matrix}{\hat{y}}^{corrected} = {y}_{t} + λ \cdot {μ}_{E} ; \\ {μ}_{E} = \frac{1}{W} {\sum }_{k = 1}^{W} {e}_{t - k} ;\end{matrix}$$

where ŷ^{corrected} denotes a final prediction result obtained after adding dynamic residual feedback, ŷᵢ(θ) denotes an uncorrected output result of the BO-LSTM model, and λ denotes a factor that dynamically adjusts the residual feedback intensity. A larger factor indicates a greater need for error correction, UE denotes the average level of W prediction deviation is used to capture a trend of systematic prediction deviation, where et-k represents the prediction error at a k-th past time step, and W denotes a window length;
S342, the adaptive weight formula is used to calculate the factor of dynamically adjusting the residual feedback strength and the standard deviation of the historical error in a sliding window, the adaptive weight formulas are:

$$\begin{matrix}λ = Sigmoid ( α \cdot \frac{{σ}_{E}}{{E}_{max}} ) ; \\ {σ}_{E} = \sqrt{\frac{1}{W} {\sum }_{k = 1}^{W} {( {e}_{t - k} - {μ}_{E} )}^{2} ;}\end{matrix}$$

where Sigmoid denotes a compression function, which constrains the feedback factor within an interval of [0,1], α denotes a sensitivity coefficient, regulating the response intensity of the residual feedback mechanism to error fluctuations, σ_{E} denotes the standard deviation of historical errors within the sliding window, and Eₘₐₓ denotes the maximum allowable error threshold for the system, eₜ₋ₖ denotes the prediction error at step t−k, where when the input term of the compression function for the feedback factor approaches zero, the residual feedback mechanism automatically weakens or ceases correction.

### Embodiment 1

S1, data acquisition and preprocessing;
In the embodiment, the port scheduling system, AIS ship tracking system, and local meteorological monitoring platform are used as data sources to vertically extract the ship berthing records, berth scheduling plans, regional meteorological parameters, and shore power load data in the past 60 days, and the unified time granularity is 15 minutes. By using the timestamp alignment mechanism, the asynchronously updated meteorological and dispatching data are resampled to the load time axis to construct the initial data set D1.

S2, correlation analysis and heterogeneous feature modeling;
in the embodiment, the preprocessed data set D2 obtained in step S1 is used to measure the correlation between each feature variable and the target load value based on MIC, and a variable correlation score list is constructed to divide the features into dominant and auxiliary features.

S21, MIC is calculated: For each characteristic variable xᵢ in the data set D2, the MIC(xᵢ,y) is calculated between xᵢ and the shore power load value y of the corresponding time step, the MIC value range is [0,1], and a larger value indicates a stronger nonlinear correlation;
S22, threshold setting and feature classification: The main and auxiliary division threshold is set to θ=0.6. If the MIC value of a variable and load is greater than or equal to the threshold, it is divided into the dominant feature set Xₘₐᵢₙ, otherwise, it is classified into the auxiliary feature set Xₐᵤₓ;
S23, heterogeneous branches are modeled: The dominant features are input into a set of bidirectional LSTM network structures, and the auxiliary features are input into a set of unidirectional LSTM network structures:

$$\begin{matrix}{h}_{main} = BiLSTM ( {X}_{main} ) ; \\ {h}_{aux} = LSTM ( {X}_{aux} ) ;\end{matrix}$$

S24, concatenating fusion: The outputs of the two branches are concatenated along the feature dimension to form a fusion feature map:

$${h}_{cat} = [ {h}_{main} ; {h}_{aux} ] ;$$

the fusion feature map is input into the BO-LSTM main network as the high-order representation input of load prediction.

S3, the BO-LSTM network based on Bayesian optimization, is constructed to complete the fusion feature prediction modeling;
In this embodiment, the fusion feature map h_{cat} obtained by step S2 is input into the self-built BO-LSTM neural network architecture. The network consists of four functional modules: the two-stream timing series modeling module, Bayesian optimization module, channel attention weighting module, and dynamic residual correction module.

In S3, the two-stream time series learning module includes the dominant and the auxiliary branch. The dominant branch uses bidirectional LSTM, which is divided into forward and backward, and the auxiliary branch uses standard LSTM calculation. The specific steps to obtain the dominant branch are:
S3111, forward LSTM is calculated:

$${\vec{h}}_{t}^{bi} = LSTM ( {F}_{main , t} , {\vec{h}}_{t - 1}^{bi} ) ;$$

where

$${\vec{h}}_{t}^{bi}$$

denotes a trend that the system is affected by the historical load data at the current moment, F_{main,t} denotes a dominant feature at the current moment, and

$${\vec{h}}_{t - 1}^{bi}$$

denotes a continuous influence of a historical operation of the port on the current load;
S3112, backward LSTM is calculated:

$${{h}^{↼}}_{t}^{bi} = LSTM ( {F}_{main , t} , {{h}^{↼}}_{t + 1}^{bi} ) ;$$

where

$${{h}^{↼}}_{t + 1}^{bi}$$

denotes the influence of future operating status on the current load trend;
S3113, forward and backward hidden states are concatenated along the feature dimension to form a comprehensive judgment basis hₜ^{bi} at the current moment:

$${h}_{t}^{b i} = [ {\vec{h}}_{t}^{b i} \vert \vert {{h}^{↼}}_{t}^{b i} ] ;$$

the specific steps to obtain the auxiliary branch are:
S3121, gating computations are performed, including a forget gate fₜ, input gate, iₜ, and output gate oₜ:

$${f}_{t} = σ ( {W}_{f} \cdot [ {h}_{t - 1}^{a u x} , {D}_{2}^{a u x} ] + {b}_{f} ) ;$$

$${i}_{t} = σ ( {W}_{i} \cdot [ {h}_{t - 1}^{a u x} , {D}_{2}^{a u x} ] + {b}_{i} ) ;$$

$${o}_{t} = σ ( {W}_{o} \cdot [ {h}_{t - 1}^{a u x} , {D}_{2}^{a u x} ] + {b}_{o} ) ;$$

where a Sigmoid function σ(⋅) is used to control an opening degree of a gate, W_{f}, Wᵢ, and Wₒ denote weight matrices for the forget gate, input gate, and output gate, respectively, and the auxiliary features are mapped to a gating space to control whether new information is introduced or an old state is retained,

$${h}_{t - 1}^{a u x}$$

denotes an influence of port auxiliary information on a current prediction at a previous moment, D₂^{aux} denotes the auxiliary features input at a current moment, b_{f}, bₜ, and bₒ are bias terms corresponding to the forget gate, input gate, and output gate, respectively, along with a threshold of a gating activation function is adjusted to avoid all gates being opened or closed at the same time;
S3122, the hidden state is updated, that is, the instantaneous impact prediction of the shore power load under the current berthing-job-scheduling behavior:

$${h}_{t}^{a u x} = {o}_{t} ⊙ tanh ( {c}_{t} ) ;$$

where

$${h}_{t}^{a u x}$$

denotes a final output of the current time step, and cₜ denotes a long-term memory state formed by integrating an influence of historical load and new inputs at the current time step.

In S3, the specific steps of using the Bayesian optimization module to optimize the LSTM network are as follows:
S321, a hyperparameter optimization objective function is used to minimize the RMSE on a validation set, wherein optimized LSTM network hyperparameters include hidden layers, learning rate, and dropout rate, a hyperparameter optimization objective function calculation formula is:

$$arg {min}_{θ} RMSE = \sqrt{\frac{1}{N} {\sum }_{i = 1}^{N} {( {y}_{i} - {y}_{i} ( θ ) )}^{2}} ;$$

where θ denotes a hyperparameter combination, RMSE denotes the root mean square error, N denotes the total number of time slice samples for parameter adjustment and evaluation, yᵢ is a historical observation value of the shore power system at the i-th time point, and ŷᵢ(θ) denotes a load output obtained by a current prediction;
The search space is set as follows: The number of hidden units∈[32,128], Dropout ratio∈[0.1,0.5], learning rate∈[0.0005,0.005];
S322, the tree structure Parzen estimator TPE surrogate model is used to update the posterior distribution of the parameters, and dynamically select the parameter combination that has the greatest potential to reduce the prediction error, the calculation formula is:

$$p ( θ \vert y ) = \frac{p ( y \vert θ ) p ( θ )}{p ( y )} ;$$

where y denotes a deviation between a shore power load prediction result and a real value, p(θ) denotes a hyperparameter prior distribution, represents an empirical preference of a parameter value, p(y|θ) denotes a likelihood function, that is, a distribution of the prediction error under given parameters, p(θ|y) denotes a posterior probability distribution;
S323, the posterior probability distribution is constructed, and an EI function is maximized in each iteration, the calculation formula of the EI function is:

$$EI ( θ ) = {\int }_{- ∞}^{{y}^{*}} ( {y}^{*} - y ) p ( y \vert θ ) dy ;$$

where EI(θ) denotes an expected improvement value, y* denotes a current optimal error value, y denotes a random variable of a model prediction error under a current parameter combination, and it is used to measure the performance uncertainty of the parameter combination.

In S3, the fusion output weighting module is used to introduce the concatenated dominant and auxiliary features into the channel attention mechanism to weight the fusion feature vectors. The specific steps are as follows:
S331, the channel attention weight is calculated:

$$β = Softmax ( {W}_{2} \cdot σ ( {W}_{1} \cdot GAP ( {h}_{cat} ) ) ) ;$$

where β denotes an importance weight vector of the fusion channel, softmax denotes a normalized exponential function, a response of all channels is compressed into the interval of [0,1] and normalized, W₁ and W₂ are learnable weight matrices used to model complex weighting relationships among different features, σ(⋅) denotes a ReLU function, GAP(⋅) denotes a global average pooling, an average response intensity of each feature at all time steps, and h_{cat} denotes the feature vector after fusion, which includes a complete representation of all key features at the current time in a time dimension;
S332, fusion weighted is output:

$${h}_{fuse} = β \cdot {h}_{c a t} ;$$

where h_{fuse} denotes a new feature map formed by the dominant and auxiliary features after attention weighting is used for subsequent prediction tasks.

In S3, specific steps of using a dynamic error correction module to suppress error accumulation through residual feedback are as follows:
S341, the residual feedback formula is used to calculate the residual feedback:

$${\hat{y}}^{corrected} = {\hat{y}}_{t} + λ \cdot {μ}_{E} ;$$

$${μ}_{E} = \frac{1}{W} {\sum }_{k = 1}^{W} {e}_{t - k} ;$$

where ŷ^{corrected} denotes a final prediction result obtained after adding dynamic residual feedback, ýₜ denotes an uncorrected output result of the BO-LSTM model, and λ denotes a factor that dynamically adjusts the residual feedback intensity. A larger factor indicates a greater need for error correction, μ_{E} denotes the average level of W prediction deviation is used to capture a trend of systematic prediction deviation, where eₜ₋ₖ represents the prediction error at a k-th past time step, and W denotes a window length;
in specific application scenarios, the window length needs to take into account feedback sensitivity and anti-interference ability, and is automatically adjusted according to the load change rate. When the port operation fluctuates frequently, it can be appropriately reduced to improve the response speed of the model to the error offset. Conversely, it can be increased to stabilize the feedback control.

In the embodiment, the window length is set to 12, and the time step is 15 minutes, indicating that the residual correction module will review the load forecasting deviation of the past three consecutive hours when performing feedback adjustment;
S342, the adaptive weight formulas are used to calculate the factor of dynamically adjusting the residual feedback strength and a standard deviation of the historical error in a sliding window, the adaptive weight formula is:

$$λ = Sigmoid ( α \cdot \frac{{σ}_{E}}{{E}_{m ax}} ) ;$$

$${σ}_{E} = \sqrt{\frac{1}{W} {\sum }_{k = 1}^{W} {( {e}_{t - k} - {μ}_{E} )}^{2}} ;$$

where Sigmoid denotes a compression function, which constrains the feedback factor within an interval of [0,1], α denotes a sensitivity coefficient, regulating the response intensity of the residual feedback mechanism to error fluctuations, σ_{E} denotes the standard deviation of historical errors within the sliding window, and Eₘₐₓ denotes a maximum allowable error threshold for the system, eₜ₋ₖ denotes the prediction error at step t−k, where when the input term of the compression function for the feedback factor approaches zero, the residual feedback mechanism automatically weakens or ceases correction.

Where the sensitivity coefficient α is set to a positive real number between 1 and 6, which is used to control the response amplitude of the system to the fluctuation degree of the prediction error. The larger value is suitable for port operation scenarios with frequent load fluctuations or abnormal suddenness, which can quickly amplify the residual feedback ratio; the smaller value is suitable for the port areas with a regular operation rhythm and stable load, which may inhibit excessive correction.

Therefore, the present disclosure provides a two-stream LSTM method for predicting power load of port shore. This method realizes the time series dynamic perception of various factors such as ship type, berth operation cycle and meteorological conditions, effectively improves the accuracy and expressiveness of load prediction, significantly reduces the time of parameter adjustment and the consumption of computing resources, effectively suppresses the accumulation of long-term prediction errors, and ensures the stability of prediction results.

Finally, it should be noted that the above embodiments are only used to explain the technical solutions of the present disclosure rather than to restrict them. Although the present disclosure is described in detail with reference to the preferred embodiments, those of ordinary skill in the art should understand that they can still modify or equivalently substitute the technical solutions of the present disclosure, and these modifications or equivalent substitutions cannot make the modified technical solutions divorce from the spirit and scope of the technical solutions of the present disclosure.

What is claimed is:

1. A two-stream Long Short-Term Memory (LSTM) method for predicting shore power loads, comprising:
S1, using longitudinal data to select and collect factors that affect power load data, obtaining a multivariate time series data set D1, and preprocessing the data set D1 to obtain a data set D2;
S2, performing correlation analysis to classify dominant and auxiliary features based on a correlation degree between each variable and load in a Maximal Information Coefficient (MIC) quantitative data set D2; inputting dominant and auxiliary features into separate heterogeneous LSTM branches for modeling, wherein dominant features undergo bidirectional LSTM modeling while auxiliary features undergo unidirectional LSTM modeling; and concatenating output results to generate a fusion feature map;
S3, constructing a Bayesian Optimization-Long Short-Term Memory (BO-LSTM) neural network, and inputting a fusion feature map into a two-stream time series learning module, extracting a deep representation of the dominant and auxiliary features respectively, and concatenating them, then introducing a channel attention mechanism to weight a fusion feature vector, an finally, outputting a power load prediction value by a residual correction module.

2. The two-stream LSTM method for predicting shore power loads according to claim 1, wherein in S1, the factors that affect the power load data comprise ship berthing information, meteorological parameters and port scheduling data, wherein the ship berthing information comprise ship type, berthing start time, end time, and berthing duration; the meteorological environment parameters comprise a temperature and rainfall of a predicted area; and the port scheduling data comprise berth usage status, expected berthing plan, current operation progress percentage, and remaining operation time.

3. The two-stream LSTM method for predicting shore power loads according to claim 1, wherein in S1, steps of preprocessing the data set D1 comprise data cleaning, missing value processing, data standardization, timing alignment and enhancement; the longitudinal data selection is based on a timestamp alignment mechanism to filter a time series dimension of associated data, and specific steps of using the longitudinal data selection to collect the factors that affect the power load data are as follows:
S11, setting a data slicing rule according to a port operation cycle, and extracting a continuous effective load section;
S12, eliminating invalid data in a non-operation period; and, S13, ensuring that filtered data remains continuous and seamless along a timeline, with a missing rate below a preset threshold.

4. The two-stream LSTM method for predicting shore power loads according to claim 1, wherein in S2, the dominant feature is a high-correlation feature, and the auxiliary feature is a low-correlation feature.

5. The two-stream LSTM method for predicting shore power loads according to claim 1, wherein in S2, the correlation analysis is performed, and the dominant features along with auxiliary features are divided based on the correlation degree between each variable and load in MIC quantitative data set D2; the dominant and auxiliary features are input into separate heterogeneous LSTM branches for modeling, the dominant features are modeled by bidirectional LSTM, and the auxiliary features are modeled by unidirectional LSTM, wherein specific steps for concatenating the output results to generate the fusion feature map are as follows:
S21, inputting data: feature variables contained in the data set D2 are recorded as X={x₁, x₂, . . . , xₙ}, wherein n represents number of features, including but not limited to ship berthing information, meteorological parameters, and port scheduling data; a historical load value of the port shore power system is taken as a target variable, which is recorded as y;
S22, calculating MIC: for each pair of features xᵢ and target variable y, calculating the MIC of the feature and load, and a calculation formula is:
$$MIC ( {x}_{i} , y ) = {max}_{{G}_{x} , {G}_{y}} \frac{I * ( {x}_{i} , y ; {G}_{x} , {G}_{y} )}{log min ( \vert {G}_{x} \vert , \vert {G}_{y} \vert )} ;$$
wherein xᵢ is the characteristic variable of an i-th input, and y denotes the load value target variable, Gₓ and G_{y} divide a range of the variable x and y into different numbers of grids, respectively, and I*(xᵢ, y; Gₓ, G_{y}) denotes a maximum mutual information value between variables xᵢ and y under given grid partitions Gₓ and G_{y};
S23, setting a correlation threshold: the threshold θ is set empirically based on several characteristics of a port and a load response intensity; wherein when MIC(xᵢ, y)≥θ, the variables are highly correlated with load changes and are divided into dominant features; otherwise, they are classified as auxiliary features; and wherein a value range of correlation discriminant threshold θ is within an interval of [0.5, 0.8];
S24, generating a dominant and auxiliary feature subset: the dominant feature set is designated Xₘₐᵢₙ, the auxiliary feature set is designated Xₐᵤₓ; an output result is evaluated according to: X=Xₘₐᵢₙ∪XₐᵤₓXₘₐᵢₙ∩Xₐᵤₓ=Ø;
S25, encoding the dominant and auxiliary features in parallel in separate branches, and concatenating the encoded outputs along a feature dimension, wherein a formula for generating the fusion feature map is:
$${h}_{cat} = [ {h}_{main} ; {h}_{aux} ] ;$$
wherein h_{cat} denotes the feature vector after fusion, hₘₐᵢₙ denotes a hidden state of a dominant branch, and hₐᵤₓ denotes a hidden state of an auxiliary branch.

6. The two-stream LSTM method for predicting shore power loads according to claim 1, wherein in S3, the BO-LSTM neural network comprises a two-stream time series learning module, a Bayesian optimization module, an attention feature fusion module, and a dynamic error correction module; wherein the BO-LSTM network outputs a current time step ŷ^{corrected} as a final prediction result after heterogeneous modeling of dominant and auxiliary features, Bayesian parameter self-optimization, attention weighted enhancement, and residual correction.

7. The two-stream LSTM method for predicting shore power loads according to claim 6, wherein in S3, the two-stream time series learning module comprises the dominant and the auxiliary branches, the dominant branch uses bidirectional LSTM, which is divided into forward and backward, and the auxiliary branch uses standard LSTM calculation, wherein specific steps to obtain the dominant branch are:
S3111, calculating forward LSTM:
$${\vec{h}}_{t}^{bi} = LSTM ( {F}_{m a i n , t} , {\vec{h}}_{t - 1}^{b i} ) ;$$
wherein
$${\vec{h}}_{t}^{bi}$$
denotes a trend that a system is affected by the historical load data at a current moment, F_{main,t} denotes a dominant feature at the current moment, and
$${\vec{h}}_{t - 1}^{bi}$$
denotes a continuous influence of a historical operation of the port on a current load;
S3112, calculating the backward LSTM:
$${{h}^{↼}}_{t}^{bi} = L S T M ( {F}_{main , t} , {{h}^{↼}}_{t + 1}^{bi} ) ;$$
wherein
$${{h}^{↼}}_{t + 1}^{bi}$$
denotes an influence of future operating status on a current load trend;
S3113, concatenating the forward and backward hidden states along the feature dimension to form a comprehensive judgment basis hₜ^{bi} at the current moment:
$${h}_{t}^{bi} = [ {\vec{h}}_{t}^{bi} \text{\vert \vert} {{h}^{↼}}_{t}^{bi} ] ;$$
wherein specific steps to obtain the auxiliary branch are:
S3121, performing gating computations including a forget gate fₜ, input gate, iₜ, and output gate oₜ:
$${f}_{t} = σ ( {W}_{f} \cdot [ {h}_{t - 1}^{aux} , {D}_{2}^{aux} ] + {b}_{f} ) ;$$
$${i}_{t} = σ ( {W}_{i} \cdot [ {h}_{t - 1}^{aux} , {D}_{2}^{aux} ] + {b}_{i} ) ;$$
$${o}_{t} = σ ( {W}_{o} \cdot [ {h}_{t - 1}^{aux} , {D}_{2}^{aux} ] + {b}_{o} ) ;$$
wherein a Sigmoid function σ(⋅) is used to control an opening degree of a gate, W_{f}, Wᵢ, and Wₒ denote weight matrices for the forget gate, input gate, and output gate, respectively, and the auxiliary features are mapped to a gating space to control whether new information is introduced or an old state is retained, hₜ₋₁^{aux} denotes an influence of port auxiliary information on a current prediction at a previous moment, D₂^{aux} denotes the auxiliary features input at a current moment, b_{f}, bₜ, and bₒ are bias items corresponding to the forget gate, input gate, and output gate, respectively, along with a threshold of a gating activation function is adjusted to avoid all gates being opened or closed at the same time;
S3122, updating a hidden state instantaneous impact prediction of shore power load under a current berthing-job-scheduling behavior:
$${h}_{t}^{aux} = {o}_{t} ⊙ tan h ( {c}_{t} ) ;$$
wherein
$${h}_{t}^{aux}$$
denotes a final output of the current time step, and cₜ denotes a long-term memory state formed by integrating an influence of historical load and new inputs at the current time step.

8. The two-stream LSTM method for predicting shore power loads according to claim 6, wherein in S3, specific steps for using a Bayesian optimization module to optimize the LSTM network are as follows:
S321, using a hyperparameter optimization objective function to minimize a root mean square error (RMSE) on a validation set, wherein optimized LSTM network hyperparameters comprise hidden layers, learning rate, and dropout rate, a hyperparameter optimization objective function calculation formula is:
$$arg {min}_{θ} R M S E = \sqrt{\frac{1}{N} {\sum }_{i = 1}^{N} {( {y}_{i} - {y}_{i} ( θ ) )}^{2}} ;$$
wherein θ denotes a hyperparameter combination, RMSE denotes the root mean square error, N denotes a total number of time slice samples for parameter adjustment and evaluation, yᵢ denotes a historical observation value of the shore power system at the i-th time point, and ŷᵢ(θ) denotes a load output obtained by a current prediction;
S322, using a tree structure Parzen estimator TPE surrogate model to update a posterior distribution of parameters, and selecting a parameter combination with the greatest potential dynamically to reduce a prediction error, a calculation formula is:
$$p ( θ \vert y ) = \frac{p ( y \vert θ ) p ( θ )}{p ( y )} ;$$
wherein y denotes a deviation between a shore power load prediction result and a real value, p(θ) denotes a hyperparameter prior distribution, represents an empirical preference of a parameter value, p(y|θ) denotes a likelihood function that is a distribution of the prediction error under given parameters, and p(θ|y) denotes a posterior probability distribution;
S323, constructing the posterior probability distribution, and maximizing an expected improvement (EI) function in each iteration, wherein a calculation formula of the EI function is:
$$E I ( θ ) = {\int }_{- ∞}^{{y}^{*}} ( {y}^{*} - y ) p ( y \vert θ ) dy ;$$
wherein EI(θ) denotes an expected improvement value, y* denotes a current optimal error value, and y denotes a random variable of a model prediction error under a current parameter combination, and is used to measure a performance uncertainty of the parameter combination.

9. The two-stream LSTM method for predicting shore power loads according to claim 6, wherein in S3, a fusion output weighting module is used to introduce the concatenated dominant and auxiliary features into the channel attention mechanism to weight the fusion feature vectors, wherein the specific steps are as follows:
S331, calculating a channel attention weight:
$$β = Softmax ( {W}_{2} \cdot σ ( {W}_{1} \cdot G A P ( {h}_{cat} ) ) ) ;$$
wherein β denotes an importance weight vector of the fusion channel, softmax denotes a normalized exponential function, the response of all channels is compressed into the interval of [0,1] and normalized, W₁ and W₂ are learnable weight matrices used to model complex weighting relationships among different features, σ(⋅) denotes a ReLU function, GAP(⋅) denotes global average pooling, defined as an average response intensity of each feature at all time steps, and h_{cat} denotes the feature vector after fusion, which comprises a complete representation of all key features at current time in a time dimension;
S332, outputting fusion weighted result:
$${h}_{fuse} = β \cdot {h}_{cat} ;$$
wherein h_{fuse} denotes a new feature map formed by the domain and auxiliary features after attention weighting is used for subsequent prediction tasks.

10. The two-stream LSTM method for predicting shore power loads according to claim 6, wherein in S3, specific steps for using a dynamic error correction module to suppress error accumulation through residual feedback are as follows:
S341, using a residual feedback formula to calculate a residual feedback:
$${\hat{y}}^{corrected} = {\hat{y}}_{t} + λ \cdot {μ}_{E} ;$$
$${μ}_{E} = \frac{1}{W} {\sum }_{k = 1}^{W} {e}_{t - k} ;$$
wherein ŷ^{corrected} denotes a final prediction result obtained after adding dynamic residual feedback, ŷᵢ(θ) denotes an uncorrected output result of the BO-LSTM model, and λ denotes a factor that dynamically adjusts the residual feedback intensity wherein a larger factor indicates a greater need for error correction, μ_{E} denotes an average level of W prediction deviation used to capture a trend of systematic prediction deviation, wherein eₜ₋ₖ represents the prediction error at k-th past time step, and W denotes a window length;
S342, using an adaptive weight formula to calculate the factor for dynamically adjusting the residual feedback strength and a standard deviation of the historical error in a sliding window, adaptive weight formulas are:
$$λ = Sigmoid ( α \cdot \frac{{σ}_{E}}{{E}_{max}} ) ;$$
$${σ}_{E} = \sqrt{\frac{1}{W} {\sum }_{k = 1}^{W} {( {e}_{t - k} - {μ}_{E} )}^{2}} ;$$
wherein Sigmoid denotes a compression function, which constrains the feedback factor within an interval of [0,1], α denotes a sensitivity coefficient, regulating the response intensity of the residual feedback mechanism to error fluctuations, σ_{E} denotes the standard deviation of historical errors within the sliding window, and Eₘₐₓ denotes maximum allowable error threshold for the system, eₜ₋ₖ denotes the prediction error at step t−k, wherein when the input term of the compression function for the feedback factor approaches zero, the residual feedback mechanism automatically weakens or ceases correction.
